(19) United States
(12) Patent Application Publication
(10) Pub. No.: US 2004/0232768 A1
(43) Pub. Date: Nov. 25, 2004

(54) PORTABLE ELECTRONIC DEVICE FOR RECEIVING POWER OVER A NETWORK

(76) Inventors: Pai-Fu Hung, Tai-Nan City (TW); Ren-Horng You, San-Hua Town (TW); Feng-Hsueh Wang, Kao-Hsiung City (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,941

(22) Filed: May 21, 2003

(51) Int. Cl. H02J 3/02; H02J 3/34

(52) U.S. Cl. 307/3; 320/140; 361/679; 340/310.01

(57) ABSTRACT

A portable electronic device connected to a network for receiving electrical power from the network. The portable electronic device includes a circuit for detectingand receiving electrical power over the network, and a power converter electrically connected to the circuit for receiving the electrical power from the circuit, converting the received electrical power such that converted electrical power has power characteristics compatible with the portable electronic device.

### BACKGROUND OF INVENTION

1. Field of the Invention

The present invention relates to a portable electronic device, and more specifically, to a portable electronic device for receiving powertransmitted over a network,such as Ethernet.

2. Description of the Prior Art

Conventional notebook computers must rely on an external AC adapter or batteries to supply power to the notebook computer. In fact, the same is true for any portable electronic device. For convenience, the following description will use a notebook computer to represent power issues relevant to all portable electronic devices.

FIG. 1 is a diagram of a notebook computer 10 connected to a network 16 and to an AC power outlet 18 according to the prior art.

The notebook computer 10 connects to an AC power adapter 20 for supplying electrical power from the AC power outlet 18 to the notebook computer 10, and to a network cable 12 via an RJ-45 connector 14 for connecting the notebook computer 10 to the network 16.

A problem with the prior art notebook computer 10 is the inconvenience of supplying power to the notebook computer 10. When connecting the notebook computer 10 to the network 16, a user has two choices for supplying power to the notebook computer 10. The first choice is to use batteries in the notebook computer 10 to supply electrical power. However, a major problem with using batteries is a limited duration to power the notebook computer 10. The second choice is using the AC power adapter 20 to connect the notebook computer 10 to the AC power outlet 18. But it is very bothersome to carry the AC power adapter 20 around with the notebook computer 10, and decreases the portability and attractiveness of the notebook computer 10. Moreover, it takes time to set up the AC power adapter 20 each time the notebook computer 10 is moved to a different location.

### SUMMARY OF INVENTION

It is therefore a primary objective of the claimed invention to provide a portable electronic device for receivingpower transmitted over a network, such as Ethernet.

According to the claimed invention, a portable electronic device includes a circuit coupled to a network for receiving pre-processed power not processed by said circuit and generating post-processed power processed by said circuit, and a power converter coupled to said circuit for converting said post-processed power to converted power for providing power supply to said portable electronic device.

It is an advantage of the claimed invention that the power conversion system is able to supply electrical power to the portable electronic device through power transmitted over a network. The claimed system eliminates the need for an AC power adapter and the dependence on batteries to supply power to the portable electronic device.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of a notebook computer connected to a network and to an AC power outlet according to the prior art.

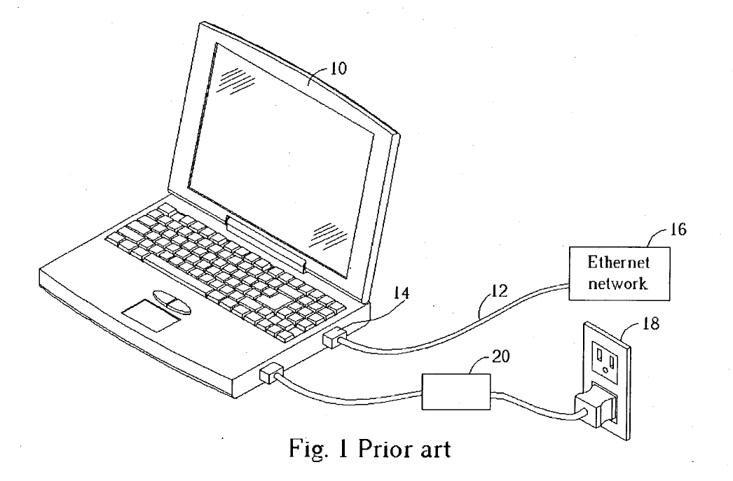

FIG. 2 is a diagram of a portable electronic device for receiving power through a network according to the present invention.

FIG. 3 is a block diagram of a power conversion system in the portable electronic device receiving power through the network according to the present invention.

FIG. 4 is a detailed block diagram of the power conversion system of the electronic device shown in FIG. 3.

FIG. 5 is a block diagram of a network power splitter according to the present invention.

### DETAILED DESCRIPTION

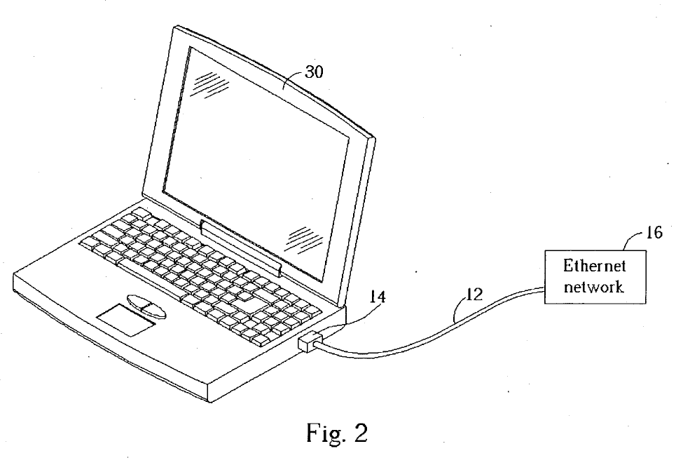

FIG. 2 illustrates a diagram of a portable electronic device 30 for receiving power through a network 16 according to the present invention. In the preferred embodiment of the present invention, the network 16 is a 10/100BaseT Ethernet network. Once the portable electronic device 30 is connected to the network 16 through the network cable 12, no power adapter and/or power cord is required to supply electrical power to the portable electronic device 30. Instead, all that is needed is a power conversion system,embedded in the portable electronic device 30, for converting power received from the network to meet the electrical requirements of the portable electronic device.

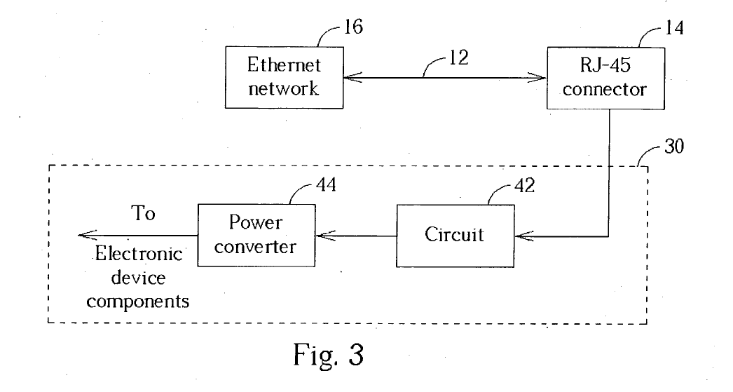

FIG. 3 is a block diagram of a power conversion system in the portable electronic device 30 for receiving power through the network 16 according to the present invention. As with the prior art, anetwork cable 12 is connected to the network 16 at one end, and has an RJ-45 connector 14 at the other end for connecting the portable electronic device 30 to the network 16.

The power conversion system of the portable electronic device 30 includes a circuit 42 for receiving power transmitted through the RJ-45 connector 14 and a power converter 44 for converting the power to meet the electrical requirements of the portable electronic device. However, other type of connectors can be used to connect the portable electronic device 30 to the network 16 besides an RJ-45 connector 14, and the circuit 42 can connect to more than one connector. That is, the present invention is capable of using any type of cable or connector to connect the portable electronic device 30 to the network 16.

The circuit 42 receives electrical power from the network 16, processes the electrical power, and and feeds this processed power into the power converter 44 for proper voltage and current conversion. The converted power is then fed into other components in the portable electronic device 30.

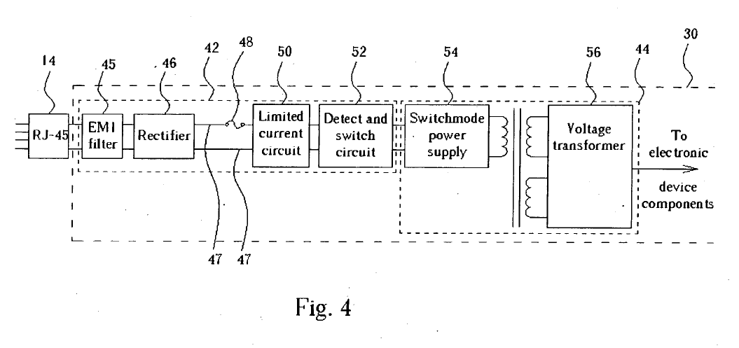

FIG. 4 is a detailed block diagram of the power conversion system of the portable electronic device 30 with the circuit 42 for receiving electrical power transmitted over the network 16,as shown in FIG. 3. The circuit 42 includes an electromagnetic interference (EMI) filter 45 electrically connected to the RJ-45 connector 14 for isolating EMI from the network 16. A rectifier circuit 46 is electrically connected to the EMI filter 45 for rectifying power received from the network 16 according to different pin configurations used in the RJ-45 connector 14. A limited current circuit 50 is electrically connected to the rectifier circuit 46 for preventing an exceedingly large amount of current from being transmitted to the portable electronic device 30. The limited current circuit Skis connected to the rectifier circuit 46 through a twisted pair 47, with a fuse polyswitch 48 being used for further protecting the portable electronic device 30. The circuit 42 also comprises a detect and switch circuit 52 for detecting compliance with the IEEE 802.3af standard or other detecting method, and switching on and off accordingly. The power converter 44 includes a switchmode power supply 54 for providing power management and power supply functions. A voltage transformer 56 is electrically connected to the switchmode power supply 54 for providing a correct operating voltage to the portable electronic device 30, such as 1.3, 1.8, 2.0, or 3.3 Volts.

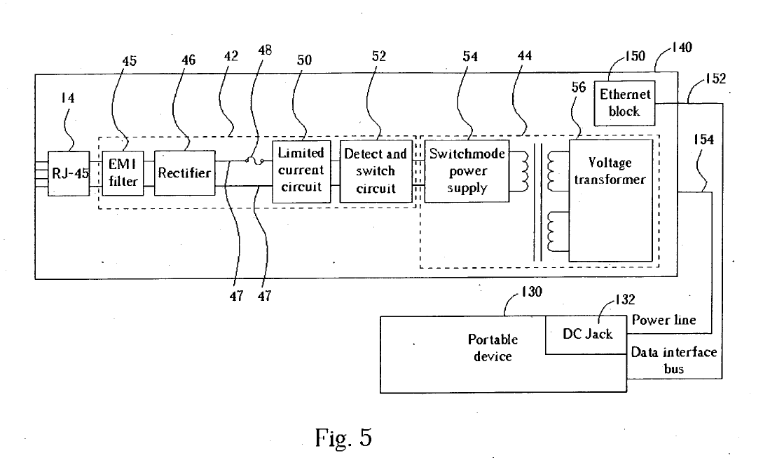

FIG. 5 is a block diagram of a network power splitter 140 according to the present invention. The network power splitter 140 shown in FIG. 5 is an external power adapter that can supply power extracted from a network to a portable electronic device 130, which does not have a function for directly receiving power transmitted over the network. The network power splitter 140 also includes the circuit 42 and the power converter 44 for providing a proper operating voltage to the portable electronic device 130. Since the detailed explanation of the circuit 42 and the-power converter 44 has been given in the explanation of FIG. 4, it will not be repeated again for brevity. In addition, the network power splitter 140 also includes a network block 150 for transmitting data between the network 16 and at least one portable electronic device 130. A data interface bus 152 transmits data between the portable electronic device 130 and the network power splitter 140. The portable electronic device 130 includes a DC jack 132 for receiving power from the network power splitter 140 through a power wire 154. Therefore, the network power splitter 140 can be used with many different portable electronic devices for supplying DC power and data communication to the portable electronic devices. The network power splitter 140 can also be used with more than one portable electronic device at a time.

The main advantage of the power conversion system of the present invention portable electronic device 30 is convenience of use. When connecting the portable electronic device 30 to the network 16, only the network cable 12 needs to be plugged into the portable electronic device 30, eliminating the need for an AC power adapter. Moreover, while the portable electronic device 30 is being used, electrical power supplied by the network 16 can be used to power the portable electronic device 30. Furthermore, any batteries electrically connected to the portable electronic device 30 can be charged by power received from the network 16 when the portable electronic device 30 is in normal mode, shut-off mode, stand-by mode, power-saving mode, or sleep mode.

Compared to the prior art, the present invention portable electronic device 30 uses a circuit 42 and a power converter 44 to convert electrical power transmitted over network 16 to electrical power that can be used by the portable electronic device 30. When connecting the portable electronic device 30 to a network 16, no power adapter is needed to supply power to the electronic device. Furthermore, limited battery life is no longer an issue for the portable electronic device 30having the function of receiving power over the network 16, and the batteries can even be recharged by power received from the network 16.

Please note that the present invention can be used with any network or local area network that complies with IEEE 802.3af standards or that is able to supply power to portable electronic devices. Moreover, although notebook computers are used in the figures to illustrate the present invention, the present invention is not limited to notebook computers. The present invention applies to any portable electronic device that can connect to a network such as a personal digital assistant (PDA), tablet computer, stock ticker, etc.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A portable electronic device comprising:
a circuit coupled to a network for receiving pre-processed power not processed by said circuit and generating post-processed power processed by said circuit; and
a power converter coupled to said circuit for converting said post-processed power to converted power for providing power supply to said portable electronic device.

2. The portable electronic device of claim 1, wherein said converted power is used to charge one or more batteries coupled to said portable electronic device under a mode selected from a group consisting of a normal operating mode, a shut-off mode, a stand-by mode, a power-saving mode and a sleep mode.

3. The portable electronic device of claim 1, wherein saidcircuit is coupled to said network via one or more RJ-45 connectors.

4. The portable electronic device of claim 1, wherein said network is an Ethernet.

5. A network power splitter comprising:
a circuit coupled to a network for receiving pre-processed power not processed by said circuit and generating post-processed power processed by said circuit;
a power converter coupled to said circuit for converting said post-processed power to converted power; and
one or more power output interfaces for outputting said converted power to one or more portable electronic devices.

6. The network power splitter of claim 5 further comprising one or more network interfaces for transmitting data between saidnetwork and saidone or more portable electronic devices.

7. The network power splitter of claim 5, wherein saidcircuit is coupled to said network via one or more RJ-45 connectors.

8. The network power splitter of claim 5, wherein said network is an Ethernet.

9. A method for supplying power to a portable electronic device, comprising the steps of:
receiving pre-processed power, not processed by a circuit coupled to said portable electronic device, from a computer network;
generating post-processed power processed by said circuit;
and
converting said post-processed power to converted power according to a voltage requirement of said portable electronic device.
